(19) United States
(12) Patent Application Publication
(10) Pub. No.: US 2023/0382683 A1
(43) Pub. Date: Nov. 30, 2023

(54) ELEVATOR CONTROL DEVICE

(71) Applicant: Panasonic Intellectual Property Management Co., Ltd., Osaka (JP)

(72) Inventor: Yoshifumi KORI, Kyoto (JP)

(21) Appl. No.: 18/232,993

(22) Filed: Aug. 11, 2023

Related U.S. Application Data
(63) Continuation of application No. PCT/JP2022/005981, filed on Feb. 15, 2022.

(30) Foreign Application Priority Data
Feb. 22, 2021 (JP) 2021-026248

(51) Int. Cl. B66B 1/34; B66B 1/06

(52) U.S. Cl. CPC B66B 1/3407; B66B 1/3476; B66B 1/06

(57) ABSTRACT

An elevator control device controls an elevator including a cage that a person and a robot get on, and the elevator control device includes: a storage that stores a rated weight of the cage; and a controller that sets a set maximum weight that is set during operation of the elevator as a maximum value of a weight loaded on the cage, wherein when the controller determines that the robot is waiting to get on the cage while the set maximum weight is set at the rated weight, the controller sets, as the set maximum weight, a limit maximum weight that is a weight less than or equal to a value obtained by subtracting a weight of the robot from the rated weight.

### TECHNICAL FIELD

The present disclosure relates to an elevator control device.

### BACKGROUND ART

An elevator control device is conventionally known that can achieve both conveyance of a user and conveyance of a robot (see, for example, PTL 1). In the configuration of PTL 1, when an instruction to choose a change to a robot-dedicated operation mode is received from an elevator monitoring center while an elevator cage is being moved, in a user-dedicated operation mode, to a destination floor of a user, the movement of the cage to the destination floor of the user is continued. Then, after a call from a new user is disabled and the cage is moved to the destination floor of the user in the cage, the user-dedicated operation mode is switched to the robot-dedicated operation mode.

### CITATION LIST

### Patent Literature

PTL 1: Unexamined Japanese Patent Publication No. 2009-51617

### SUMMARY OF THE INVENTION

An elevator control device according to an aspect of the present disclosure controls an elevator including a cage that a person and a robot get on, and the elevator control device includes: a storage that stores a rated weight of the cage; and a controller that sets a set maximum weight that is set during operation of the elevator as a maximum value of a weight loaded on the cage, wherein when the controller determines that the robot is waiting to get on the cage while the set maximum weight is set at the rated weight, the controller sets, as the set maximum weight, a limit maximum weight that is a weight less than or equal to a value obtained by subtracting a weight of the robot from the rated weight.

### BRIEF DESCRIPTION OF THE DRAWINGS

FIG. 1 is a schematic diagram of an elevator control system according to a first exemplary embodiment.

FIG. 2 is a flowchart illustrating an operation of the elevator control system according to the first exemplary embodiment.

FIG. 3 is a flowchart illustrating an operation of an elevator control system according to a second exemplary embodiment.

FIG. 4 is a flowchart illustrating an operation of elevator control systems according to third and fourth exemplary embodiments.

FIG. 5 is a flowchart illustrating an operation of the elevator control system according to the third exemplary embodiment.

FIG. 6 is a flowchart illustrating an operation of the elevator control system according to the fourth exemplary embodiment.

FIG. 7 is a flowchart illustrating an operation of elevator control systems according to fifth and sixth exemplary embodiments.

FIG. 8 is a flowchart illustrating an operation of the elevator control system according to the fifth exemplary embodiment.

FIG. 9 is a flowchart illustrating an operation of the elevator control system according to the sixth exemplary embodiment.

### DESCRIPTION OF EMBODIMENT

In the configuration described in PTL 1, since control is performed in a mode in which only a user or a robot can use the elevator; therefore, in a case where the user and the robot use the same cage, there is a possibility that a waiting time until the user or the robot can use the elevator becomes long.

The present disclosure has been made to solve the above issue, and an object of the present disclosure is to provide an elevator control device capable of suppressing an increase in waiting time of a person and a robot.

### First Exemplary Embodiment

A first exemplary embodiment of the present disclosure will be described.

<Configuration of Elevator Control System>

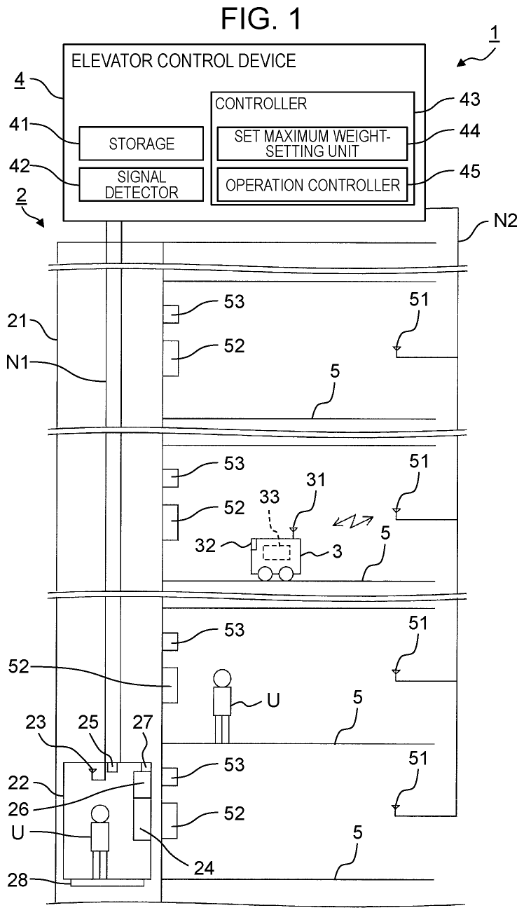

First, a configuration of an elevator control system will be described. FIG. 1 is a schematic diagram of an elevator control system according to the first exemplary embodiment of the present disclosure.

Elevator control system 1 illustrated in FIG. 1 includes elevator 2, robot 3, and elevator control device 4.

Elevator 2 conveys user (person) U and robot 3 to floors on the basis of instructions from user U and robot 3. Elevator 2 includes cage 22 that moves up and down in elevator tower 21. Cage 22 moves to each floor, being driven by a lifting device (not illustrated). Cage 22 includes cage antenna 23, cage operation unit 24, cage illuminator 25, cage notifier 26, getting on and off detector 27, loaded weight detector 28, and a cage door (not illustrated).

Cage antenna 23 is connected to elevator control device 4 via network N1. Cage antenna 23 enables transmission and reception of various signals between elevator control device 4 and robot 3 in cage 22 by wireless communication.

Cage operation unit 24 is operated by user U. Cage operation unit 24 includes, for example: an opening and closing operation unit for opening and closing the cage door; and an in-cage destination instruction unit for instructing a destination.

Cage illuminator 25 illuminates the inside of cage 22.

Cage notifier 26 notifies user U in cage 22 of information on the operation of cage 22 on the basis of the control of elevator control device 4. Cage notifier 26 includes at least one of a display unit, a light emitter, and a sound output unit. Examples of the information that cage notifier 26 notifies of may include: a warning that a loaded weight of cage 22 (a total weight of user U and robot 3) exceeds a set maximum weight; and a current position and state of movement of cage 22. The set maximum weight is a weight that is set during the operation of elevator 2 as a maximum value of a weight to be loaded on cage 22. That is, the value of the set maximum weight is changed during the operation of elevator 2, in accordance with a situation.

Getting on and off detector 27 detects getting on and off of user U and robot 3 to and from cage 22. Examples of getting on and off detector 27 may include an infrared sensor, a monitoring camera, and a weight sensor.

Loaded weight detector 28 detects a loaded weight of cage 22. Examples of loaded weight detector 28 may include a known weight sensor.

To elevator control device 4, signals are transmitted that are related to: the destination floor instructed by an operation on the in-cage destination instruction unit (hereinafter, in some cases, the floor is referred to as a “user destination floor”); getting on and off to and from cage 22 detected by getting on and off detector 27; and a loaded weight of cage 22 detected by loaded weight detector 28.

Elevator hall 5 of each floor is provided with hall antenna 51, hall operation unit 52, hall notifier 53, and hall door (not illustrated).

Hall antenna 51 is connected to elevator control device 4 via network N2. Hall antenna 51 enables transmission and reception of various signals by wireless communication between elevator control device 4 and robot 3 waiting in elevator hall 5 provided with hall antenna 51.

Hall operation unit 52 is operated by user U. Hall operation unit 52 includes, for example, an opening and closing operation unit to open and close a hall door, and a cage call instruction unit for calling cage 22.

Hall notifier 53 notifies user U in elevator hall 5 of information on the operation of cage 22 on the basis of the control of elevator control device 4. Hall notifier 53 includes at least one of a display unit, a light emitter, and a sound output unit. Examples of the information that hall notifier 53 notifies of may include: a warning that the loaded weight of cage 22 exceeds a set maximum weight; and a current position and state of movement of cage 22.

To elevator control device 4, a signal is transmitted that is related to the floor where the cage call instruction unit is operated (hereinafter, in some cases, the floor is referred to as a “user call floor”).

Robot 3 is an autonomous traveling robot. Examples of robot 3 may include: a robot that conveys a person or a load; a vacuum cleaner; a robot for various types of sensing; and a robot that communicates with a person. Robot 3 includes robot antenna 31, robot notifier 32, and robot controller 33.

Robot antenna 31 is configured such that robot 3 can transmit and receive various signals to and from cage antenna 23 in cage 22 and hall antenna 51 in elevator hall 5 by wireless communication.

Robot notifier 32 notifies user U around robot 3 of information on robot 3. Robot notifier 32 includes at least one of a display unit, a light emitter, and a sound output unit. Examples of the information that robot notifier 32 notifies of may include a destination of robot 3, and a state of movement such as turning right or left, moving forward movement, or moving backward. Note that robot notifier 32 may be provided at one of a front surface, a rear surface, a side surface, and an upper surface of robot 3, or may be provided at a plurality of positions.

Robot controller 33 controls robot 3. Robot controller 33 controls robot 3 such that robot 3 moves on a preset route or performs a preset operation. Robot controller 33 transmits, to elevator control device 4, a robot call floor signal to call cage 22 to a floor where robot 3 is waiting (hereinafter, in some cases, the floor is referred to as a “robot call floor”) and a robot destination floor signal to specify a floor where robot 3 gets off cage 22 (hereinafter, in some cases, the floor is referred to as a “robot destination floor”). Robot controller 33 transmits a robot weight signal related to the weight of robot 3 (hereinafter, in some cases, the weight is referred to as a “robot weight”) to elevator control device 4. When robot 3 is a robot conveying a person or a load, the robot weight is preferably the total weight of the weight of robot 3 itself and the weight of the person or the load being conveyed.

When receiving, from elevator control device 4, a getting on permission signal to permit robot 3 to get on cage 22, robot controller 33 controls robot 3 such that robot 3 gets on cage 22. When receiving, from elevator control device 4, a getting off permission signal to permit robot 3 to get off cage 22, robot controller 33 controls robot 3 such that robot 3 gets off cage 22.

Elevator control device 4 includes storage 41, signal detector 42, and controller 43.

Storage 41 includes a memory, a hard disk, or the like. Storage 41 stores various types of information necessary to control elevator 2 and robot 3. Storage 41 stores, for example, a user destination floor, a user call floor, a set maximum weight of cage 22, a rated weight of cage 22, a robot call floor and a robot destination floor of robot 3, and a robot weight. The rated weight is a weight preset, by the manufacturer of elevator 2, as a maximum weight allowed to be loaded on cage 22.

When detecting signals from cage operation unit 24 and hall operation unit 52, signal detector 42 stores in storage 41 information related to a user destination floor and a user call floor corresponding to the respective signals. When detecting a robot call floor signal, a robot destination floor signal, and a robot weight signal from robot 3, signal detector 42 stores in storage 41 information on a robot call floor, a robot destination floor, and a robot weight corresponding to respective ones of the signals. Note that signal detector 42 may cause storage 41 to store information related to a floor where robot 3 is waiting (robot call floor) when a waiting detector (not illustrated) detects that robot 3 is waiting in front of a hall door of a predetermined floor.

Controller 43 includes a central processing unit (CPU), and the CPU executes a program to implement a function of controller 43. Controller 43 includes set maximum weight-setting unit 44 and operation controller 45.

Set maximum weight-setting unit 44 sets the set maximum weight of cage 22 at the rated weight or the limit maximum weight. When setting the set maximum weight at the rated weight, set maximum weight-setting unit 44 sets the rated weight stored in storage 41 as the set maximum weight. When setting the set maximum weight at the limit maximum weight, set maximum weight-setting unit 44 calculates, as the limit maximum weight, a value obtained by subtracting the robot weight from the rated weight. Set maximum weight-setting unit 44 sets the calculated limit maximum weight as the set maximum weight. Set maximum weight-setting unit 44 stores the set maximum weight in storage 41.

Operation controller 45 causes cage 22 to move to the user destination floor, the user call floor, the robot call floor, or the robot destination floor, and opens the cage door and the hall door when cage 22 stops at these floors. When cage 22 stops at the robot call floor, operation controller 45 transmits a getting on permission signal to robot 3 waiting at the robot call floor to permit robot 3 to get on. When cage 22 stops at the robot destination floor, operation controller 45 transmits a getting off permission signal to robot 3 in cage 22 to permit robot 3 to get off. When operation controller 45 acquires a detection result of getting on and off detector 27 and thereby determines that the getting on and off of user U and robot 3 is finished, operation controller 45 closes the cage door and the hall door and moves cage 22 to the user destination floor, the user call floor, the robot call floor, or the robot destination floor. At the robot call floor or the robot destination floor, even when user U performs the operation of closing the cage door from cage operation unit 24, operation controller 45 desirably does not close the cage door or the hall door until it is determined that the getting on and off of robot 3 has finished.

Operation controller 45 acquires the detection result of loaded weight detector 28 during getting on and off of user U and robot 3, and determines whether the loaded weight of cage 22 exceeds the set maximum weight. When it is determined that the loaded weight of cage 22 exceeds the set maximum weight, operation controller 45 perform a getting on and off control for notifying of a warning by controlling at least either cage notifier 26 or hall notifier 53. By notifying of such a warning, it is possible to suppress to many users U from getting on cage 22. As described above, the set maximum weight is set at the rated weight in one case, and is set at the limit maximum weight in another case. Hereinafter, the getting on and off control when the set maximum weight is set at the rated weight may be referred to as a “standard getting on and off control (first getting on and off control)”, and the getting on and off control when the set maximum weight is set at the limit maximum weight may be referred to as a “limited getting on and off control (second getting on and off control)”.

Note that operation controller 45 may cause at least either cage notifier 26 or hall notifier 53 to notify that the limited getting on and off control is being performed by using a character, a symbol, light, sound, light, or the like. When notifying user U that the limited getting on and off control is being performed, the fact that the limited getting on and off control is being performed may be notified, or the number of people who can get on cage 22 may be estimated, and the estimated number of people may be notified. Examples of the number of people to be notified of may include the number of people (including user U or users U who are on board) who can newly get on or the number of people who can get on.

Examples of a method of estimating the number of people who can newly get on may include a method in which a weight obtained by subtracting the weight of user U or users U who are on board from the limit maximum weight is divided by a weight of a general person. Examples of a method of estimating the number of people (including user U or users U who are on board) who can get on the vehicle may include a method in which the limit maximum weight is divided by a weight of a general person. Furthermore, operation controller 45 may cause at least either cage notifier 26 or hall notifier 53 to notify of the fact that the standard getting on and off control is being performed.

Operation controller 45 may cause cage illuminator 25 to notify that the limited getting on and off control is being performed. Operation controller 45 may illuminate, during the limited getting on and off control, an area corresponding to a footprint (an occupation area on the floor) of robot 3 on the floor of cage 22 and the other area (area where user U can get on) with at least either different intensities or different colors. In this case, robot 3 may transmit a robot size signal related to its own footprint to elevator control device 4.

<Operation of Elevator Control System>

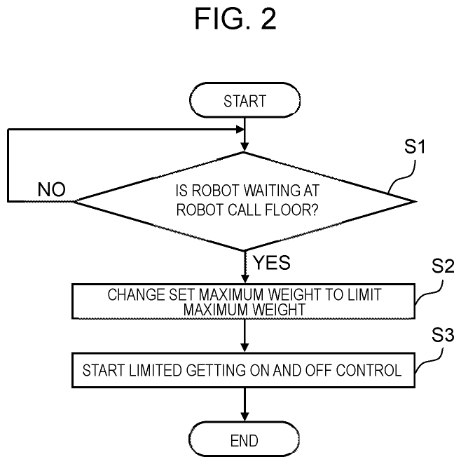

First, an operation of the elevator control system will be described. FIG. 2 is a flowchart illustrating an operation of elevator control system 1 according to the first exemplary embodiment.

While performing the standard getting on and off control, operation controller 45 determines whether robot 3 is waiting at a robot call floor (predetermined floor) (step S1). When signal detector 42 does not detect a robot call floor signal, operation controller 45 determines that robot 3 is not waiting at the robot call floor (step S1: NO), and performs processing of step S1 again after a predetermined time has elapsed.

When robot 3 itself arrives at a predetermined floor, robot 3 transmits a robot call floor signal and a robot weight signal to elevator control device 4. Note that robot 3 may transmit a robot destination floor signal at the same timing as the robot call floor signal, or may transmit the robot destination floor signal after getting on cage 22. When signal detector 42 detects the robot call floor signal, operation controller 45 determines that robot 3 is waiting at the robot call floor (step S1: YES). In this case, set maximum weight-setting unit 44 changes the set maximum weight from the rated weight to the limit set weight (step S2). When the set maximum weight is changed from the rated weight to the limit set weight, operation controller 45 ends the standard getting on and off control and starts the limited getting on and off control (step S3).

### Effects of First Exemplary Embodiment

When elevator control device 4 determines, while performing the standard getting on and off control, that robot 3 is waiting at a robot call floor, elevator control device 4 ends the standard getting on and off control and starts the limited getting on and off control. With such a configuration, user U can use elevator 2 in a range in which the loaded weight of cage 22 does not exceed the limit maximum weight even when the limited getting on and off control is being performed. Furthermore, since the limited getting on and off control is performed until cage 22 stops at the robot call floor, the number of users U exceeding the limit maximum weight is restricted from getting on cage 22, so that an estimated loaded weight of cage 22 in a case where it is assumed that robot 3 gets on cage 22 stopped at the robot call floor (the total weight of the weight of user U or users U who are getting on cage 22 and the weight of robot 3) can be made less than or equal to the rated weight. Therefore, after the limited getting on and off control is finished and the standard getting on and off control is started, robot 3 can get on cage 22 stopped at the robot call floor. Therefore, it is possible to suppress an increase in the waiting time of user U and robot 3.

Note that the timing at which the standard getting on and off control is started after the end of the limited getting on and off control only needs to be before robot 3 gets on cage 22. For example, elevator control device 4 may estimate the time required for cage 22 to reach the robot call floor in accordance with the number of user call floors and user destination floors at the point of time when robot 3 is determined to be waiting at the robot call floor, and elevator control device 4 may change the limited getting on and off control to the standard getting on and off control after the estimated required time has elapsed.

### Second Exemplary Embodiment

<Operation of Elevator Control System>

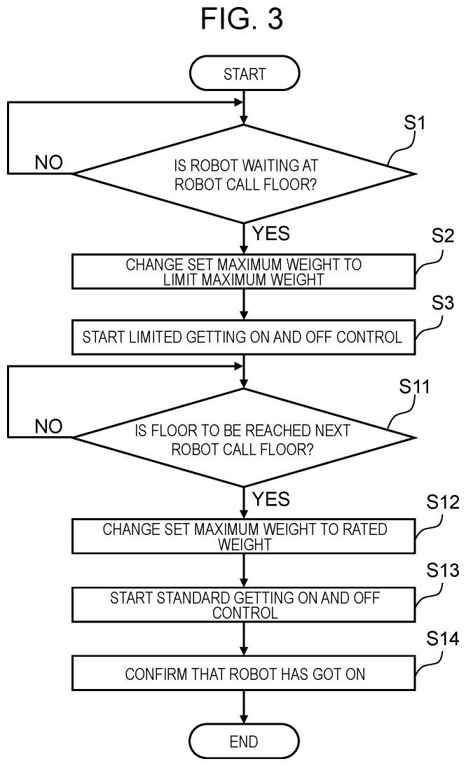

Next, a second exemplary embodiment will be described. The elevator control systems of the second exemplary embodiment and third to sixth exemplary embodiments to be described later are each different from the elevator control systems of the other embodiments in the operation of elevator control device 4. FIG. 3 is a flowchart illustrating an operation of the elevator control system according to the second exemplary embodiment. Note that the same operation as in the first exemplary embodiment will be briefly described or will not be described.

As illustrated in FIG. 3, elevator control device 4 of the second exemplary embodiment performs the processing of steps S11 to S14 to be described in detail below in addition to the processing of steps S1 to S3 described already. Elevator control device 4 performs the processing of steps S1 to S3. After a limited getting on and off control is started, operation controller 45 determines whether the floor that cage 22 reaches next is the robot call floor (step S11). If operation controller 45 determines that the floor that cage 22 reaches next is not the robot call floor (step S11: NO), operation controller 45 perform the processing of step S11 again. For example, operation controller 45 performs the processing of step S11 every time cage 22 stops at each floor and passes each floor.

If operation controller 45 determines that the floor that cage 22 reaches next is the robot call floor (step S11: YES), set maximum weight-setting unit 44 changes the set maximum weight from the limit maximum weight to the rated weight before robot 3 waiting at the robot call floor gets on cage 22 (step S12). When the set maximum weight has been changed from the limit maximum weight to the rated weight, operation controller 45 ends the limited getting on and off control and starts the standard getting on and off control (step S13).

When cage 22 has stopped at the robot call floor, operation controller 45 opens the cage door and the hall door and transmits a getting on permission signal to robot 3. The estimated loaded weight at the point of time when cage 22 stops at the robot call floor is less than or equal to the rated weight, and the standard getting on and off control is performed; therefore, robot 3 can get on cage 22. Operation controller 45 confirms that robot 3 has got on (step S14), closes the cage door and the hall door, and moves cage 22 to the user destination floor, the user call floor, or the robot destination floor. Here, the getting on of robot 3 may be confirmed by getting on and off detector 27, or may be confirmed by receiving a getting on completion signal from robot 3.

Note that robot 3 may transmit the robot destination floor signal to elevator control device 4 at the same timing as the robot call floor signal, or may transmit the robot destination floor signal after getting on cage 22. Further, the processing of steps S12 and S13 may be performed before robot 3 gets on cage 22, and may be performed after cage 22 stops at the robot call floor.

### Effects of Second Exemplary Embodiment

When elevator control device 4 determines that the floor that cage 22 reaches next is the robot call floor, elevator control device 4 ends the limited getting on and off control and starts the standard getting on and off control. As described above, regardless of whether user U gets on and off before cage 22 reaches the robot call floor, the standard getting on and off control is not started until it is determined that the floor that cage 22 reaches next is the robot call floor; therefore, it is possible to allow robot 3 to get on cage 22.

### Third Exemplary Embodiment

<Operation of Elevator Control System>

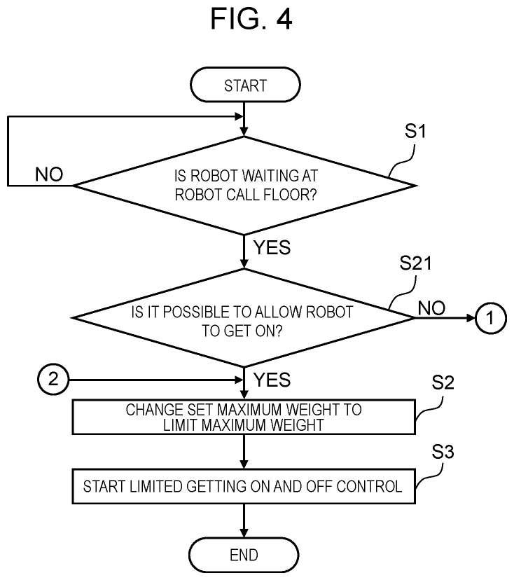

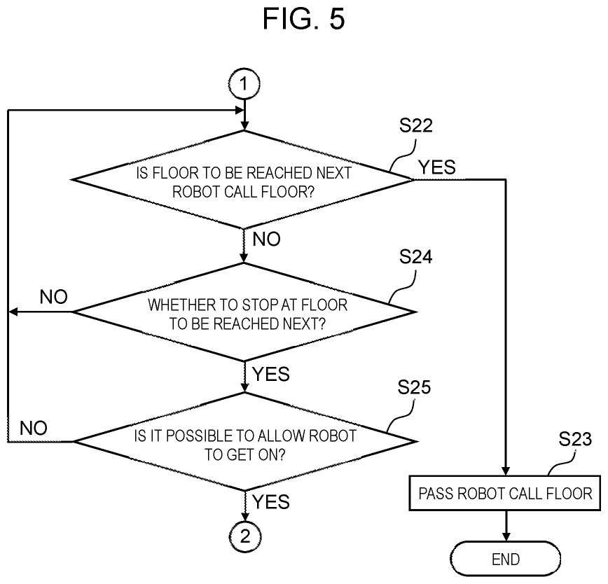

Next, the third exemplary embodiment will be described. FIGS. 4 and 5 are flowcharts illustrating an operation of the elevator control system according to the third exemplary embodiment. Note that the same operation as in the first and second exemplary embodiments will be briefly described or will not be described.

As illustrated in FIGS. 4 and 5, elevator control device 4 of the third exemplary embodiment performs the processing of steps S21 to S25 to be described in detail below in addition to the processing of steps S1 to S3 described already. Operation controller 45 of elevator control device 4 performs the processing of step S1, and if it is determined that robot 3 is waiting at a predetermined floor (step S1: YES), operation controller 45 determines whether it is possible to allow robot 3 to get on cage 22 (step S21, which is first determination processing). Operation controller 45 determines that it is possible to allow robot 3 to get on cage 22 when the estimated loaded weight of cage 22 in the following case is less than or equal to the rated weight: the case where robot 3 is assumed to get on cage 22 at the point of time when it is determined that robot 3 is waiting at the robot call floor.

If it is determined that it is possible to allow robot 3 to get on (step S21: YES), elevator control device 4 performs the processing of step S2 and the following steps to end the standard getting on and off control and to start the limited getting on and off control. If it is determined that robot 3 is not allowed to get on (step S21: NO), as shown in FIG. 5, operation controller 45 determines whether the floor that cage 22 reaches next is the robot call floor (step S22).

If operation controller 45 determines that the floor that cage 22 reaches next is the robot call floor (step S22: YES), the operation control unit causes cage 22 to pass the robot call floor (step S23). In this case, the standard getting on and off control is continued. If operation controller 45 determines that the floor that cage 22 reaches next is not the robot call floor (step S22: NO), it is determined whether to stop cage 22 at the floor to be reached next (step S24). If operation controller 45 determines not to stop cage 22 at the floor to be reached next, in other words, determines that the floor to be reached next is neither the user call floor nor the user destination floor (step S24: NO), the processing of step S22 is performed.

If operation controller 45 stops cage 22 at the floor to be reached next, in other words, determines that the floor to be reached next is at least either the user call floor or the user destination floor (step S24: YES), operation controller stops cage 22 at the floor to be reached next. After confirming that user U has got on and off, operation controller 45 determines whether the getting on and off of user U has made it possible to allow robot 3 to get on cage 22 (step S25, which is second determination processing). Here, the getting on and off of user U may be confirmed by getting on and off detector 27, and in a case where the process is performed more simply, it may be determined that user U has substantially finished getting on and off, on the basis of the cage door and the hall door being closed. Alternatively, the second determination processing may be performed based on recognizing, by real time detection of detection information of loaded weight detector 28, that the loaded weight of cage 22 becomes smaller than the limit maximum weight during getting on and off of user U. Such processing is desirably performed on the basis of the fact that a mode is selected in which getting on of robot 3 is more prioritized than getting on of user U. If it is determined that it has become possible to allow robot 3 to get on (step S25: YES), elevator control device 4 performs the processing of step S2 and the following steps to end the standard getting on and off control and to start the limited getting on and off control as shown in FIG. 4. Note that elevator control device 4 may perform the process of steps S11 to S14 of the second exemplary embodiment after performing the processing of step S3. If it is determined that it has not become possible to allow robot 3 to get on (step S25: NO), operation controller 45 performs the processing of step S22.

### Effects of Third Exemplary Embodiment

When elevator control device 4 determines that robot 3 is waiting at the robot call floor, elevator control device 4 then determines whether it is possible to allow robot 3 to get on cage 22 in a state of boarding at the time of such determination, and when it is determined that it is possible to allow robot 3 to get on cage 22, elevator control device 4 ends the standard getting on and off control and starts the limited getting on and off control. Therefore, regardless of whether user U gets on and off before cage 22 reaches the robot call floor, it is possible to cause robot 3 to reliably get on cage 22.

Even when elevator control device 4 once determined that robot 3 could not be allowed to get on, when it is determined that the subsequent getting on and off of user U has made it possible to allow robot 3 get on, elevator control device 4 ends the standard getting on and off control and starts the limited getting on and off control. Therefore, in the case where getting on and off of user U have made it possible to allow robot 3 to get on, it is possible to reliably cause robot 3 to get on cage 22.

When elevator control device 4 determines, in the state where it is kept impossible to allow robot 3 to get on, that the floor that cage 22 reaches next is the robot call floor, elevator control device 4 causes cage 22 to pass the robot call floor. Therefore, it is possible to convey user U being in cage 22 to the user destination floor more quickly.

### Fourth Exemplary Embodiment

<Operation of Elevator Control System>

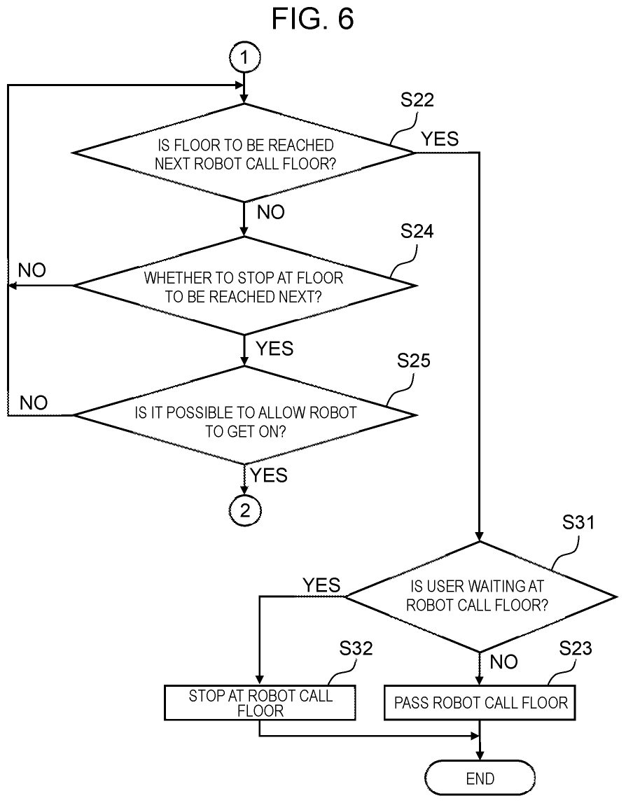

Next, the fourth exemplary embodiment will be described. FIGS. 4 and 6 are flowcharts illustrating an operation of an elevator control system according to the fourth exemplary embodiment. Note that the same operation as in the first to third exemplary embodiments will be briefly described or will not be described.

As illustrated in FIGS. 4 and 6, elevator control device 4 of the fourth exemplary embodiment performs the processing of steps S31 to S32 to be described in detail below in addition to the processing of steps S1 to S3 and S21 to S25 described already. Elevator control device 4 performs the processing of steps S1 to S3, S21, S22, S24, and S25 illustrated in FIGS. 4 and 6.

As illustrated in FIG. 6, if operation controller 45 determines that the floor that cage 22 reaches next is the robot call floor (step S22: YES), it is determined whether user U is waiting at the robot call floor (step S31). Specifically, operation controller 45 determines whether the robot call floor is the same as the user call floor. Note that operation controller 45 may determine whether user U is waiting at the robot call floor on the basis of a detection result of a sensor (not illustrated) that detects user U being at the robot call floor. If operation controller 45 determines that user U is not waiting at the robot call floor (step S31: NO), operation controller 45 causes cage 22 to pass the robot call floor (step S23). In this case, the standard getting on and off control is continued.

If operation controller 45 determines that user U is waiting at the robot call floor (step S31: YES), operation controller 45 causes cage 22 to stop at the robot call floor (step S32). Here, for example, when cage 22 stops at the robot call floor, operation controller 45 opens the cage door and the hall door, and causes at least either cage notifier 26 or hall notifier 53 to notify of one or both of the followings: that robot 3 is not allowed to get on; and that user U may get on. Note that robot notifier 32 may be caused to notify of one or both of the followings: that robot 3 is not allowed to get on and that user U may get on.

When operation controller 45 confirms that user U has finished getting on and off, operation controller 45 closes the cage door and the hall door and moves cage 22 to the user destination floor and the user call floor. In this case, the standard getting on and off control is continued.

### Effects of Fourth Exemplary Embodiment

When elevator control device 4 determines, in the state where it is kept impossible to allow robot 3 to get on cage 22, that user U is waiting at the robot call floor, elevator control device 4 causes cage 22 to stop at the robot call floor. Therefore, it is possible to allow user U waiting at the robot call floor to get on cage 22, and the waiting time of user U can be suppressed from becoming long. In particular, by not allowing robot 3 to get on, it is possible to preferentially allow user U waiting at the robot call floor to get on.

### Fifth Exemplary Embodiment

<Operation of Elevator Control System>

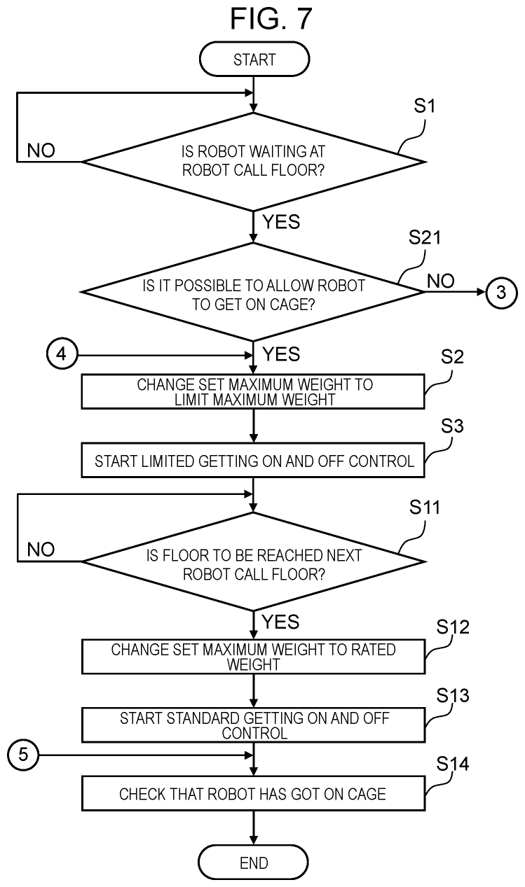

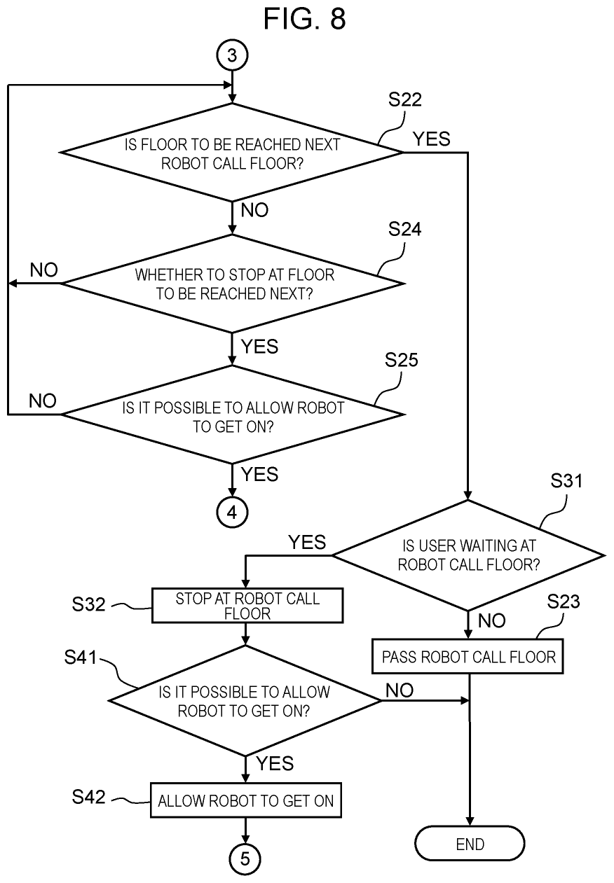

Next, the fifth exemplary embodiment will be described. FIGS. 7 and 8 are flowcharts illustrating an operation of an elevator control system according to the fifth exemplary embodiment. Note that the same operation as in the first to fourth exemplary embodiments will be briefly described or will not be described.

As illustrated in FIGS. 7 and 8, elevator control device 4 of the fifth exemplary embodiment performs the processing of steps S41 to S42 to be described in detail below in addition to the processing of steps S1 to S3, S11 to S14, S21 to S25, and S31 to S32 described already. Elevator control device 4 performs the processing of steps S1 to S3, S11 to S14, S21 to S25, and S31 to S32 illustrated in FIGS. 7 and 8.

After performing the processing of step S32, operation controller 45 confirms that user U has got on and off, and determines whether the getting on and off of user U at the robot call floor has made it possible to allow robot 3 to get on cage 22 (step S41, which is third determination processing). Here, the getting on and off of user U may be confirmed by getting on and off detector 27, and, alternatively, it may be determined that user U has substantially finished getting on and off, on the basis of user U having performed an operation to close the cage door from cage operation unit 24. Alternatively, the third determination processing may be performed based on recognizing, by real time detection of detection information of loaded weight detector 28, that the loaded weight of cage 22 becomes smaller than the limit maximum weight during getting on and off of user U. Such processing is desirably performed on the basis of the fact that a mode is selected in which getting on of robot 3 is more prioritized than getting on of user U. However, in the case where the robot call floor is the same as the user call floor, it is preferable that a mode be selected in which getting on of user U is more prioritized than getting on of robot 3. Operation controller 45 determines that it is possible to allow robot 3 to get on when the estimated loaded weight of cage 22 (=total weight loaded in cage 22+weight of robot 3) in the following case is less than or equal to the rated weight: the case where robot 3 is assumed to get on cage 22 where user U has finished getting on and off.

If operation controller 45 determines that it has become possible to allow robot 3 to get on (step S41: YES), operation controller 45 transmits a getting on permission signal to robot 3 to allow robot 3 to get on (step S42). After that, elevator control device 4 performs the process of step S14 illustrated in FIG. 7 and the following steps to cause robot 3 to get on, and continues the standard getting on and off control. If operation controller 45 determines that it has not become possible to allow robot 3 to get on (step S41: NO), operation controller 45 closes the cage door and the hall door without causing robot 3 to get on and moves cage 22 to the user destination floor and the user call floor. In this case, the standard getting on and off control is continued.

### Effects of Fifth Exemplary Embodiment

After elevator control device 4 once prohibited, at the robot call floor, robot 3 from getting on, when elevator control device 4 determines that the getting on and off of user U at the robot call floor has made it possible to allow robot 3 to get on cage 22, elevator control device 4 allows robot 3 to get on. Therefore, it is possible to suppress an increase in the waiting time of robot 3.

### Sixth Exemplary Embodiment

<Operation of Elevator Control System>

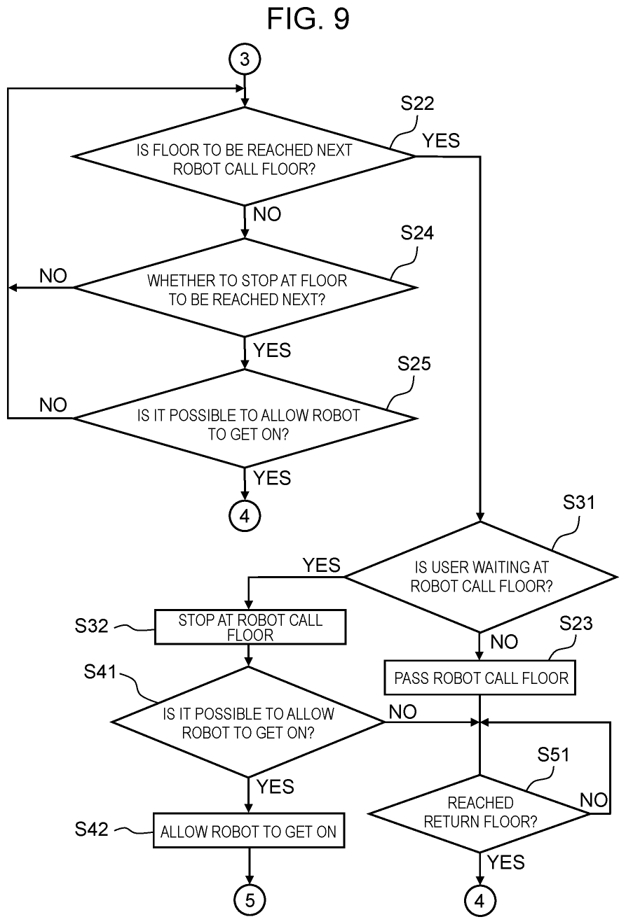

Next, the sixth exemplary embodiment will be described. FIGS. 7 and 9 are flowcharts illustrating an operation of an elevator control system according to the sixth exemplary embodiment. Note that the same operation as in the first to fifth exemplary embodiments will be briefly described or will not be described.

As illustrated in FIGS. 7 and 9, the elevator control system of the sixth exemplary embodiment performs the processing of steps S51 to be described in detail below in addition to the processing of steps S1 to S3, S11 to S14, S21 to S25, S31 to S32, and S41 to S42 described already.

Elevator control device 4 performs the processing of steps S1 to S3, S11 to S14, S21 to S25, S31 to S32, and S41 to S42 illustrated in FIGS. 7 and 9. Operation controller 45 determines that it has not become possible to allow robot 3 to get on cage 22 (step S41: NO), and operation controller 45 starts to move cage 22 to the user destination floor and the user call floor, and then determine whether cage 22 has reached a return floor (step S51). The return floor is a floor at which a lifting direction of cage 22 is changed. If operation controller 45 determines that cage 22 has reached the return floor (step S51: YES), elevator control device 4 performs the processing of step S2 and the following steps illustrated in FIG. 7 to end the standard getting on and off control and to start the limited getting on and off control. Note that the switching to the limited getting on and off control in step S2 to be performed after step S51 is desirably performed before the cage door and the hall door are opened. In particular, when the lifting direction of cage 22 is switched from a lower floor direction to an upper floor direction, it is desirable to switch to the limited getting on and off control before the cage door and the hall door are opened. This makes it possible to prevent that too many users get on cage 22 so that the weight reaches such a level that robot 3 cannot be loaded again. However, for example, in the case where the lifting direction of cage 22 is changed from the upper floor direction to the lower floor direction, switching to the limited getting on and off control may be performed after a user is lifted up and down and the cage door and the hall door are then closed. This is because there is a high possibility that the number of users on the return floor is different between the upper floor side and the lower floor side. If operation controller 45 determines that cage 22 has not reached the return floor (step S51: NO), operation controller 45 performs the processing of step S51, when cage 22 stops at the next user destination floor or the next user call floor, for example.

### Effects of Sixth Exemplary Embodiment

When cage 22 reaches the return floor after resuming the movement of cage 22 to the user destination floor and the user call floor without allowing robot 3 to get on cage 22 at the robot call floor, elevator control device 4 changes the set maximum weight from the rated weight to the limit set weight and starts the limited getting on and off control. Therefore, robot 3 can reliably get on cage 22 having returned.

### Modifications of Exemplary Embodiment

It goes without saying that the present disclosure is not limited to the embodiments described above, and various modifications can be made without departing from the spirit of the present disclosure. In addition, the above exemplary embodiments and the following modifications may be combined in any way as long as they function normally.

For example, the first to sixth exemplary embodiments describe as examples of a configuration in which robot 3 transmits a robot call floor signal, a robot destination floor signal, and a robot weight signal to elevator control device 4 (instructions, of a robot call floor, a robot destination floor, and a robot weight, to elevator control device 4), but the transmission may be performed by a robot management system that manages robot 3.

The first to sixth exemplary embodiments describe, as an example, a configuration in which robot 3 transmits a robot weight signal, but the configuration may be made as follows. A database representing the relationship between identifiers of robots 3 and robot weights may be stored in storage 41 of elevator control device 4 or a server accessible from set maximum weight-setting unit 44, and a function to transmit a signal representing an identifier of robot 3 is provided on robot 3 or a robot management device, so that set maximum weight-setting unit 44 can specify the robot weight on the basis of the identifier based on the received signal and on the basis of the database.

The first to sixth exemplary embodiments describe, as an example, a configuration in which set maximum weight-setting unit 44 calculates a limit maximum weight on the basis of a robot weight of robot 3 that has transmitted a robot call floor signal. However, as the limit maximum weight, a value may be calculated by subtracting, from the rated weight, the robot weight of the heaviest robot 3 among the robots 3 having a possibility of using elevator control system 1, regardless of the robot weight of robot 3 that has transmitted the robot call floor signal. In other words, set maximum weight-setting unit 44 may calculate, as the limit maximum weight, a value less than or equal to a value obtained by subtracting the robot weight of robot 3 that has transmitted the robot call floor signal, from the rated weight.

In the third to sixth exemplary embodiments, during the limited getting on and off control started in the processing of step S3, when a time period in which the loaded weight of cage 22 exceeds the set maximum weight (the limit maximum weight) becomes longer than a predetermined period even though a warning that the loaded weight have exceeded the set maximum weight is issued, elevator control device 4 may end the limited getting on and off control, start the standard getting on and off control, and perform the processing of step S11. With such a configuration, a large number of users U can be preferentially conveyed.

According to the elevator control device of the present disclosure, it is possible to suppress an increase in waiting time of a person and a robot.

### INDUSTRIAL APPLICABILITY

The present disclosure is applicable to an elevator control device.

### REFERENCE MARKS IN THE DRAWINGS

1 elevator control system
2 elevator
3 robot
4 elevator control device
5 elevator hall
21 elevator tower
22 cage
23 cage antenna
24 cage operation unit
25 cage illuminator
26 cage notifier
27 getting on and off detector
28 loaded weight detector
31 robot antenna
32 robot notifier
33 robot controller
41 storage
42 signal detector
43 controller
44 set maximum weight-setting unit
45 operation controller
51 hall antenna
52 hall operation unit
53 hall notifier
N1, N2 network
U user

1. An elevator control device that controls an elevator including a cage that a person and a robot get on, the elevator control device comprising:
a storage that stores a rated weight of the cage; and
a controller that sets a set maximum weight that is set during operation of the elevator as a maximum value of a weight loaded on the cage, wherein when the controller determines that the robot is waiting to get on the cage while the set maximum weight is set at the rated weight, the controller sets, as the set maximum weight, a limit maximum weight that is a weight less than or equal to a value obtained by subtracting a weight of the robot from the rated weight.

2. The elevator control device according to claim 1, wherein when a floor where the cage stops next is a floor where the robot is waiting, the controller sets the rated weight as the set maximum weight before the robot gets on the cage.

3. The elevator control device according to claim 1, wherein
the controller performs first determination processing of determining whether the robot is allowed to get on the cage at a point of time when the controller determines that the robot is waiting to get on the cage, and
when the controller determines, in the first determination processing, that the robot is allowed to get on, the controller sets the limit maximum weight as the set maximum weight.

4. The elevator control device according to claim 3, wherein
when the cage stops at a floor during a time period from when the controller determines, in the first determination processing, that the robot is not allowed to get on to when the cage reaches the floor where the robot is waiting, the controller performs second determination processing of determining whether the robot is allowed to get on the cage, and
when the controller determines, in the second determination processing, that the robot is allowed to get on, the controller sets the limit maximum weight as the set maximum weight.

5. The elevator control device according to claim 4, wherein in a case where it is not determined, in the second determination processing and before the cage reaches the floor where the robot is waiting, that the robot is allowed to get on, the controller controls the elevator and causes the cage to pass the floor where the robot is waiting.

6. The elevator control device according to claim 5, wherein even in a case where it is not determined, in the second determination processing and before the cage reaches the floor where the robot is waiting, that the robot is allowed to get on, the controller controls the elevator and causes the cage to stop at the floor where the robot is waiting when a person is waiting at the floor where the robot is waiting.

7. The elevator control device according to claim 6, wherein
when the cage stops at the floor where the robot is waiting, the controller performs third determination processing of determining whether the robot is allowed to get on the cage, and
when the controller determines, in the third determination processing, that the robot is allowed to get on, the controller allows the robot to get on the cage.

8. The elevator control device according to claim 5, wherein in a case where a lifting direction of the cage is changed after the cage pass the floor where the robot is waiting without the robot getting on the cage, the controller sets the limit maximum weight as the set maximum weight.
